(19) United States
(12) Patent Application Publication
(10) Pub. No.: US 2005/0100716 A1
(43) Pub. Date: May 12, 2005

(54) Watercolor canvas

(76) Inventor: James R. January, Sugar Hill, GA (US)

Correspondence Address: TECHNOPROP COLTON, L.L.C., P O BOX 567685, ATLANTA, GA, 311567685, US

(21) Appl. No.: 10/706,427

(22) Filed: Nov. 12, 2003

(51) Int. Cl. B32B 3/00

(52) U.S. Cl. 428/195.1

(57) ABSTRACT

A coated substrate suitable for accepting water-based paints, pencils, and inks, in which the substrate is coated with the coating, and the coating is formulated to accept water-based paints, pencils, and inks without unacceptable running or bleeding of the water-based paints, pencils, and inks in and on the coating.

### BACKGROUND OF THE INVENTION

1. Technical Field

The present invention is generally in the field of materials used as substrates on which artists can paint an more specifically in the field of coated canvases for artistic painting and in the field of coatings for canvases and the coated canvases allowing the canvas to be used as a medium for accepting watercolor paints.

2. Prior Art

Historically, watercolor and related methods of painting have primarily used paper as a medium. There have been coatings produced that could be applied to rigid surfaces to make these substrates accept watercolors. But papers must be handled with great care, and rigid substrates can quickly become cumbersome to handle owing to their weight and bulk. To the inventor's knowledge and belief, no one has successfully produced a coated canvas material that could be used for watercolor painting or drawing techniques. A coated canvas would allow for much greater latitude in options for mounting in preparation for painting. Unlike papers and rigid substrates, canvas can be stretched. And unlike rigid substrates, canvas can be rolled up for transport as well as being much lighter in weight.

Currently, artist canvas is almost exclusively coated with on of two types of priming material: water-based latexes or oil-based paints. There currently are no commercially successful coated canvases that are sold especially for the purpose of watercolor painting. Neither the latex- or oil-based priming materials have properties that properly allow for watercolor painting. The surfaces of latex- and oil-based priming materials tend to be hydrophobic and repel water rather than absorb it as would be necessary for watercolor techniques.

There are coatings and related systems related to inkjet printing with water-based inks. However, in most cases, these systems are unsuitable for watercolor techniques because of physical or performance limitations. In many cases, these systems simply are not able to tolerate the large amount of water involved in watercolor techniques. These systems either are damages by the water or cannot absorb enough water to allow for the practical application of watercolors.

U.S. Pat. No. 3,853,579 to Heiser discloses a coating containing a plastic polymeric pigment for applying to a paper substrate. The coating is both for opacifying the paper and for providing an improved writing surface. The coating comprises discrete, substantially spheroid, plastic, polymeric particle pigment having an average diameter in the 0.3 to 0.8 micron range. Interestingly, the patent claims require printing applied to the coating, which leads us to believe that the specific formula for the coating may not be overly unique. In any event, this is a paper coating and is not for allowing one to watercolor on canvas.

Several of the known but unsuitable inventions include the following coating and printing techniques.

U.S. Pat. No. 4,065,596 to Groody discloses an artist's board comprising a rigid backer, a front paintable member and in intermediate resilient member with the purpose of the intermediate member being to allow the front member to flex so that the entire board has the feel of canvas alone. U.S. Pat. No. 4,562,107 to Daniels discloses coating textile fabrics with a curable polymer binder, an opacifier, and a pigment to obtain washfast, opaque printed areas that are substantially unaffected by the base color of the fabric. U.S. Pat. No. 5,167,704 to Brower discloses a soy based ink meant to simulate watercolor without the disadvantage of watercolors. U.S. Pat. No. 5,700,522 to Nonweiler discloses aqueous emulsion-based coating compositions with a latex binder whose primary use is for coating hard substances, such as polymers and metals.

U.S. Pat. No. 5,700,858 to Deir discloses a plastisol paint that requires heat curing to harden. U.S. Pat. No. 6,051,059 to Aisner discloses a liquid art medium for creating three-dimensional art and contains an acrylic polymer. U.S. Pat. Nos. 6,258,412 and 6,423,379 to Ewing disclose a method of making an artistic medium that is mineral based in an acrylic polymer binder. U.S. Pat. Nos. 6,403,673 and 6,410,363 to Groves disclose water dispersed primers for improving adhesion to substrates and is photoreactive. U.S. Patent Publication No. 2002/0066515 to Zirker discloses acrylic paint monotype artwork and is for a method for producing artwork using acrylic paints and gels.

Plain untreated or uncoated canvas absorbs water and therefore when watercolor is applied to plain canvas, the colors bleed. The prior art coatings and systems do not allow for the coating of a stretchable and flexible canvas or similar material that will accept watercolor painting media. So, for this reason, people do not watercolor on canvas. Accordingly, there is a need for a coated canvas that will accept watercolor media. The present invention is directed to his need and other needs as disclosed in this specification.

### BRIEF SUMMARY OF THE INVENTION

The present invention is a flexible coated material that can be used as a medium for watercolor and related techniques and methods and also are suitable for inkjet printing using water-based inks. The present invention covers both woven and non-woven materials comprising a coating formulated to properly accept watercolor paints, watercolor pencils, acrylic paints and water-based inks applied by inkjet printers, and also may be suitable for painting with oils and for drawing with pastels and pencils. Thus, the present invention may be considered a multi-purpose material canvas for use with all of the major coloring media.

Canvas is the preferred substrate because of its common use by artists for acrylic and oil paintings. Although a wide variety of natural and synthetic materials can be used to weave the canvas, the preferred embodiment uses natural fibers such as cotton and linen, which have a greater affinity for moisture making them a preferred base for the large amounts of water that are a part of these techniques.

The coatings are based on water-based latexes such as latexes based on acrylic and vinyl polymers, and combinations thereof, with acrylic latexes being preferred owing to their demonstrated utility and durability as a medium for artist applications. The coatings also comprise materials to provide the wetting and absorption of water by the latexes. An illustrative formulation for an exemplary coating comprises acrylic latex, pigment, defoamer, calcium carbonate, talc, surfactant, polyvinyl alcohol, and water.

Many illustrative features, objects and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a side sectional view of an exemplary coated woven substrate.

FIG. 2 is a side sectional view of an exemplary coated non-woven substrate.

### DETAILED DESCRIPTION OF THE PREFERRED EMBODIMENTS

The present invention is a coated material that can be used as a medium for watercolor and related techniques and methods. This material also is suitable for inkjet printing using water-based inks. The present invention covers both woven and non-woven substrate materials comprising a coating formulated to properly accept watercolor paints, watercolor pencils, acrylic paints and water-based inks applied by inkjet printers. Further, this coated material also may be suitable for painting with oils and for drawing with pastels and pencils, and thus may be considered a multi-purpose material for use with all of the major coloring media.

While both woven and non-woven substrate materials are suitable for this invention, the preferred embodiment uses a woven substrate material such as canvas because of its likeness to those canvases used by artists for acrylic and oil paintings. And while a wide variety of natural and synthetic materials can be used to weave the canvas, the preferred embodiment uses a material made with natural fibers such as cotton and linen. Natural fibers have a greater affinity for moisture making them a preferred base for the large amounts of water that are a part of these painting techniques.

The coatings disclosed for this invention are based on water-based latexes commonly used to prepare artist canvas for the more traditional painting methods utilizing acrylic or oil paints. Latexes based on acrylic and vinyl polymers, as well as combinations of acrylic and vinyl polymers, are part of this invention. Acrylic latexes are preferred owing to their demonstrated utility and durability as a medium for artist applications.

The coatings for this invention incorporate materials to provide the wetting and absorption of water by the latexes. The amount of these materials necessary, however, is unexpectedly low so that the basic physical properties of the coating are not substantially compromised. This allows the finished article, namely the canvas, to be scrubbed to repair or remove a mistake or other undesirable features in a painting without harming the coating.

Preferred embodiments of the coatings comprise the components shown in Table 1.

TABLE 1
COATING COMPONENTS

| | Preferred Range |
|---|---|
| Component | (parts by weight) |
| Water-based latex | 100-200 |
| Pigment dispersant | 0-5 |
| Defoamer | 0-2 |
| Pigments and Fillers | 75-150 |
| Extenders | 0-50 |
| Surfactant | 0-5 |
| Water | 10-50 |

After dispersing the pigment dispersant, defoamer, pigments and fillers, extenders, and surfactant in the latex and water to create a paint mixture, the paint mixture is mixed with a water soluble polymer to create the coating mixture. Generally, the water soluble polymer is first is dispersed in additional water, and the water soluble polymer and water mixture is added to the paint mixture, as the water soluble polymer and water mixture is hydrophilic. Preferably from 5 to 20 parts by weight of water soluble polymer is mixed with from 80 to 95 parts by weight of water. The inclusion of a water soluble polymer is to allow for the proper absorption of water by the coating and canvas.

The water soluble polymer can be added to the paint mixture at ratios of 1 to 30 weight percent based on the weight of the solids in the paint. For example, if a paint formula was 60 weight percent solids, there would be 0.6 to 18 parts of water soluble polymer for each 100 parts of paint mixture (60 parts of paint solids). The preferred ratio would be 2 to 10 weight percent of the water soluble polymer.

The coating mixture then is coated onto the substrate, allowed to dry or is dried, and the resulting coated substrate is suitable for accepting watercolors.

The latex base can be selected from the group consisting of but not limited to acrylic latexes, vinyl latexes, polyvinyl latexes, other common and known latexes, and mixtures thereof.

The pigment dispersant can be selected from the group consisting of but not limited to known, common, and future developed pigment dispersants suitable in the coating field in general and the paint-related coating field in general.

The defoamer can be selected from the group consisting of but not limited to known, common, and future developed defoamers suitable in the coating field in general and the paint-related coating field in general.

The pigment and filler can be selected from the group consisting of but not limited to titanium dioxide, calcium carbonate, magnesium carbonate, magnesium silicate, clay, inorganic colors, barium sulfate, mica, zinc oxide, zinc dust, metallics, carbon blacks, organic colors, silica, other silicates, aluminates, sulphates, carbonates, other common and known pigments and fillers, and mixtures thereof.

The extender can be selected from the group consisting of but not limited to china clay, kaolin clay, talc, silica, whiting, metal stearates, gypsum, mica, barite, blanc fixe, other common and known extenders, and mixtures thereof.

The surfactant can be selected from the group consisting of but not limited to known, common, and future developed surfactants suitable in the coating field in general and the paint-related coating field in general.

The water soluble polymer can be selected from the group consisting of but not limited to polyvinyl alcohol, polyethylene oxide, cellulose and its derivatives, polyvinyl pyrrolidone, starch, animal hide glue, gum arabic, xanthan gum and guar gum.

A typical illustrative formulation for the coating is shown in Table 2.

TABLE 2
ILLUSTRATIVE COATINGS

| | Preferred Range | Illustrative Formula 1 |
|---|---|---|
| Component | (parts by weight) | (parts by weight) |
| Acrylic latex | 100-200 | 150 |
| Pigment dispersant | 0-5 | 2 |
| Defoamer | 0-2 | 0.8 |
| Calcium carbonate | 75-150 | 115 |
| Talc | 0-50 | 20 |
| Surfactant | 0-5 | 2 |
| Water | 10-50 | 30 |

As above, after dispersing the pigment dispersant, defoamer, calcium carbonate, talc, and surfactant in the latex and water to create a paint mixture, the paint mixture is mixed with a water soluble polymer such as polyvinyl alcohol and water mixture to create the coating mixture. In this example, 12 parts by weight of polyvinyl alcohol is mixed with 88 parts by weight of water to form the polyvinyl alcohol and water mixture.

Additional illustrative formulations for the coating are shown in Table 3.

TABLE 3
Additional Illustrative Coatings

| | Illustrative Formula 2 | Illustrative Formula 3 |
|---|---|---|
| Component | (parts by weight) | (parts by weight) |
| Acrylic latex | 140 | 150 |
| Pigment dispersant | 2 | 2 |
| Defoamer | 0.8 | 0.8 |
| Calcium carbonate | 95 | 0 |
| Kaolin clay | 0 | 100 |
| Titanium dioxide | 18 | 20 |
| Talc | 14 | 0 |
| Surfactant | 1 | 2 |
| Water | 30 | 30 |

As above, after dispersing the pigment dispersant, defoamer, calcium carbonate or kaolin clay, titanium dioxide, talc if used, and surfactant in the latex and water to create a paint mixture, the paint mixture of Illustrative Formula 2 is mixed with a water soluble polymer such as 100 parts by weight of Vivprint 540 brand water soluble polymer (10% solution in water), and the paint mixture of Illustrative Formula 3 is mixed with a water soluble polymer such as Polyox N-80 brand water soluble polymer (25% solution in water) to create the additional illustrative coating mixtures.

Although many different components are suitable for the coating mixture, one example coating utilized Phoplex AC-19 brand acrylic latex from Rohm and Haas, Tamol 731 brand pigment dispersant from Rohm and Haas, Foamaster NDW defoamer from Henkel, and Triton X165 surfactant from Union Carbide.

When the illustrative coating was coated onto several pieces of a 5 oz/yd², 100% cotton canvas at a rate of about 3 oz/yd² add-on, the resultant coated canvas was tested by a professional watercolor artist and found to be very acceptable as a medium for watercolor painting. The coated canvas accepted the watercolor paints even when the paints were highly diluted with water. The coated canvas also accepted watercolor pencil and allowed the pencil to then be spread via the addition of water.

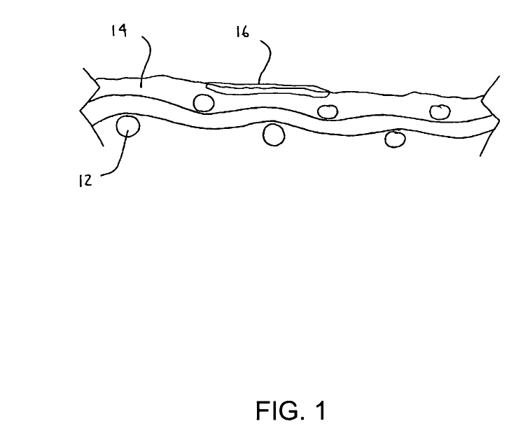

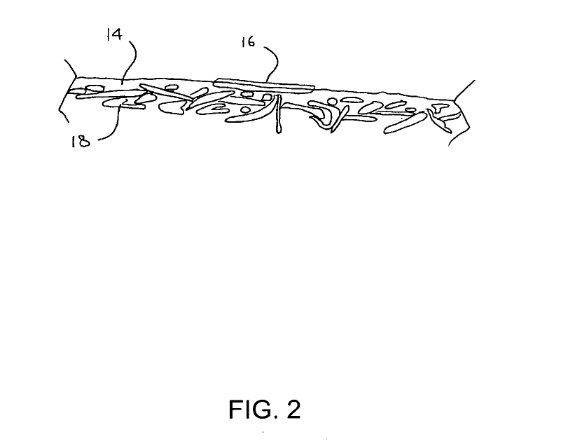

FIGS. 1 and 2 illustrate simplistic sectional side views of the invention. FIG. 1 shows a woven substrate 12, such as a canvas, coated with the coating 14. Watercolor 16 is illustrated painted onto the coating 14. FIG. 2 shows a non-woven substrate 18, such as a felt, coated with the coating 14. Watercolor 16 is illustrated painted onto the coating 14.

The coated canvas worked with dry-brush techniques or could be pre-wetted with water. Further, the coated canvas allowed color to be removed to create effects such as clouds. Additionally, the professional artist demonstrated that the watercolor paints even could be removed by wetting the sample and wiping with a cloth. This allowed the artist to repaint on the same sample, a step that would be impossible with uncoated paper substrates.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

1. A coated substrate suitable for accepting water-based paints, pencils, and inks, comprising a substrate and a coating on the substrate, wherein the coating is formulated to accept water-based paints, pencils, and inks without unacceptable running or bleeding of the water-based paints, pencils, and inks in and on the coating.

2. The coated substrate as claimed in claim 1, wherein the substrate is selected from the group consisting of woven and non-woven materials.

3. The coated substrate as claimed in claim 1, wherein the substrate is selected from the group consisting of canvas made from natural and synthetic fibers.

4. The coated substrate as claimed in claim 1, wherein the substrate is a flexible canvas selected from the group consisting of cotton and linen canvases.

5. The coated substrate as claimed in claim 1, wherein the coating is made from a paint mixture comprising a water-based latex.

6. The coated substrate as claimed in claim 5, wherein the paint mixture further comprises filler and water.

7. The coated substrate as claimed in claim 6, wherein the paint mixture further comprises pigment dispersant, defoamer, extender and surfactant.

8. The coated substrate as claimed in claim 1, wherein the coating is made from a paint mixture comprising from 100-200 parts by weight water-based latex, 0-5 parts by weight pigment dispersant, 0-2 parts by weight defoamer, 75-150 parts by weight pigment and filler, 0-50 parts by weight extender, 0-5 parts by weight surfactant, and 0-50 parts by weight water.

9. A coated substrate suitable for accepting water-based paints, pencils, and inks, comprising a substrate and a coating on the substrate, wherein the coating is formulated to accept water-based paints, pencils, and inks without unacceptable running or bleeding of the water-based paints, pencils, and inks in and on the coating, wherein the substrate is a flexible canvas selected from the group consisting of cotton and linen canvases and the coating is made from a paint mixture comprising from 100-200 parts by weight water-based latex, 0-5 parts by weight pigment dispersant, 0-2 parts by weight defoamer, 75-150 parts by weight pigment and filler, 0-50 parts by weight extender, 0-5 parts by weight surfactant, and 0-50 parts by weight water.

10. The coated substrate as claimed in claim 9, wherein the water-based latex is an acrylic latex.

11. The coated substrate as claimed in claim 10, wherein the pigment and filler is calcium carbonate.

12. The coated substrate as claimed in claim 11, wherein the extender is talc.

13. The coated substrate as claimed in claim 12, wherein the paint mixture comprises from 150 parts by weight water-based latex, 2 parts by weight pigment dispersant, 0.8 parts by weight defoamer, 115 parts by weight calcium carbonate, 20 parts by weight extender, 2 parts by weight surfactant, and 30 parts by weight water.

14. A coating for applying to a substrate, the coating being suitable for accepting water-based paints, pencils, and inks, wherein the coating is formulated to accept water-based paints, pencils, and inks without unacceptable running or bleeding of the water-based paints, pencils, and inks in and on the coating.

15. The coating as claimed in claim 14, wherein the coating is made from a paint mixture comprising a water-based latex.

16. The coating as claimed in claim 15, wherein the paint mixture further comprises filler and water.

17. The coating as claimed in claim 16, wherein the paint mixture further comprises pigment dispersant, defoamer, extender and surfactant.

18. The coating as claimed in claim 14, wherein the coating is made from a paint mixture comprising from 100-200 parts by weight water-based latex, 0-5 parts by weight pigment dispersant, 0-2 parts by weight defoamer, 75-150 parts by weight pigment and filler, 0-50 parts by weight extender, 0-5 parts by weight surfactant, and 0-50 parts by weight water.

19. A coating for applying to a substrate, the coating being suitable for accepting water-based paints, pencils, and inks, wherein the coating is formulated to accept water-based paints, pencils, and inks without unacceptable running or bleeding of the water-based paints, pencils, and inks in and on the coating, wherein the coating is made from a paint mixture comprising from 100-200 parts by weight water-based latex, 0-5 parts by weight pigment dispersant, 0-2 parts by weight defoamer, 75-150 parts by weight pigment and filler, 0-50 parts by weight extender, 0-5 parts by weight surfactant, and 0-50 parts by weight water.

20. The coated substrate as claimed in claim 19, wherein the water-based latex is an acrylic latex.

21. The coated substrate as claimed in claim 20, wherein the pigment and filler is calcium carbonate.

22. The coated substrate as claimed in claim 21, wherein the extender is talc.

23. The coated substrate as claimed in claim 22, wherein the paint mixture comprises from 150 parts by weight water-based latex, 2 parts by weight pigment dispersant, 0.8 parts by weight defoamer, 115 parts by weight calcium carbonate, 20 parts by weight extender, 2 parts by weight surfactant, and 30 parts by weight water.
